(19) United States
(12) Patent Application Publication
(10) Pub. No.: US 2026/0220356 A1
(43) Pub. Date: Jul. 30, 2026

(54) WORK SUPPORT SYSTEM AND WORK SUPPORT METHOD

(71) Applicant: Hitachi, Ltd., Tokyo (JP)

(72) Inventors: Takuya KOBAYASHI, Tokyo (JP); Takehiro NIIKURA, Tokyo (JP)

(21) Appl. No.: 19/441,618

(22) Filed: Jan. 6, 2026

(30) Foreign Application Priority Data
Jan. 30, 2025 (JP) 2025-014390

(51) Int. Cl. G06F 40/166

(52) U.S. Cl. CPC G06F 40/166

(57) ABSTRACT

A work support system that outputs work support text to improve the worker's work includes, a data acquisition unit that receives operational data indicating the worker's operations, a hierarchical operation text generation unit generates operation description text explaining the operational data across multiple levels, an operation DB stores the generated operation description text, an input unit receives instructional text for task support from the worker, a text selection agent selects the worker's operational data and the comparison operational data specified by the received instructional text from the operation DB based on the received instructional text, a support text generation agent that generates work support text based on the requested worker's operational data and the comparison operational data specified by the instructional text, and an output unit that outputs the generated work support text.

### CROSS REFERENCE TO RELATED APPLICATIONS

This application claims priority to Japanese Patent Application No. 2025-014390, filed January 30, 2025, the contents of which are incorporated herein by reference in its entirety for all purposes.

### TECHNICAL FIELD

The present invention relates to a work support system and work support method.

### BACKGROUND ART

Conventionally, methods have been proposed for converting an operator's operational data into natural language format for the purpose of supporting the operator's work, and for generating useful support text for the work from the natural language format operational data. Patent Document 1 discloses a technology that converts all diverse sensor data collectable from manufacturing sites into natural language format. Subsequently, it enables interactive access to the natural language sensor data using a user interface and chatbot, generating necessary support text for the user on an ad hoc basis.

### CITATION LIST

### Patent Document

[Patent Document 1] International publication No. WO 2024/211603 A1

### SUMMARY OF THE INVENTION

### PROBLEMS TO BE SOLVED BY THE INVENTION

Conventional systems do not address the issue of "hierarchy of operation" when verbalizing human operations. When flexibly generating operation-based work support text according to support objectives, it is difficult to focus on the appropriate part of the operation and generate text accordingly.

The "hierarchy of operation" problem refers to the redundancy that exists in describing the same observed work operation as different text, depending on how the operation is segmented (hierarchy based on granularity) and its importance in the work (hierarchy based on importance).

For example, when observing a screw tightening task using a manual screwdriver, this can be expressed as the task name "screw tightening operation." However, it can also be described in fine detail using the worker's operations: "The left arm extends and lightly supports the screwdriver, while the right arm extends to grasp the screwdriver, twisting the forearm from the elbow down" (hierarchy based on granularity).

Furthermore, when describing operations using the aforementioned granular breakdown, descriptions of the worker's posture, such as operations involving the lower limbs or torso are not included. This is because the operations of these body parts have a low degree of direct relevance to the task content.

For example, it is possible to add an expression such as "lowering the hips and leaning the torso forward while..." to accompany the above description (hierarchy based on importance). Beyond the hierarchy of the operation itself, if information regarding interaction with the surrounding environment or data from others performing the same task is available, it is also possible to describe operations related to interaction or operation variations. This includes information indicating the work object, the building where the work is performed, the work location, the line, the tools or equipment used, the worker's position, etc. (addition of peripheral information).

Various types of text expressing operational data can each become important information depending on the specific task support required by the subject. However, when converted into natural language format, they tend to become confused or partially omitted.

When answering operator questions using verbalized information, operational data can be converted into natural language format by pre-storing it as multiple text based on a "hierarchy of operation" This allows interactive generation of work support text, selecting the most relevant texts for each support request. The present invention aims to provide a work support system that focuses on the appropriate points in an operation and generates text accordingly.

### SOLUTIONS TO PROBLEMS

The above issue is resolved by a work support system that outputs work support text to improve worker tasks comprising, a data acquisition unit receives operational data indicating worker operation, a hierarchical operation text generation unit that generates operation description texts explaining the operational data across multiple levels, an operation DB that stores the generated operation description texts, an input unit that receives instructional text for work support from the worker, a text selection agent selects the worker's operational data and the comparison target operational data specified by the received instructional text for work support from the operation DB based on the received instructional text for work support, a support text generation agent generates work support text based on the requested worker's operational data and the comparison operational data specified by the work support instructional text, and an output unit that outputs the generated work support text.

### EFFECTS OF THE INVENTION

According to the present invention, it becomes possible to generate work support text relevant to the work content.

### BRIEF DESCRIPTION OF THE DRAWINGS

FIG. 1 is an example block diagram showing the system configuration of the work support system in an embodiment.

FIG. 2 is an example of a hardware configuration diagram of the work support system in the embodiment.

FIG. 3 is an example of a data relationship diagram for the work support system in the embodiment.

FIG. 4 shows an example of operational data in an embodiment.

FIG. 5 is an example of 3D data in the embodiment.

FIG. 6 is an example of a user information registration screen in the embodiment.

FIG. 7 is an example of hierarchical operation text in the embodiment.

FIG. 8 is an example of interaction text in the embodiment.

FIG. 9 is an example of operation comparison text in an embodiment.

FIG. 10 is an example of an operation database in an embodiment.

FIG. 11 is a diagram showing the processing of the similar operation matching unit in the embodiment.

FIG. 12 is an example of the work support screen in the embodiment.

FIG. 13 is an example of a flowchart showing the work support processing in the embodiment.

FIG. 14 is an example of a flowchart showing the operation support processing with hierarchical specification in the embodiment.

FIG. 15 is a diagram showing the processing of the operation text selection agent in the embodiment.

FIG. 16 is a diagram showing the processing of the support text generation agent in the embodiment.

FIG. 17 is an example of a flowchart showing the operational data registration process in an embodiment.

FIG. 18 is a diagram showing the operational data registration process in an embodiment.

### METHOD FOR CARRYING OUT THE INVENTION

The embodiment will now be described in detail with reference to the drawings. However, the present invention is not limited to the description of the embodiment shown below. Examples involving modifications to the specific configurations, provided they do not deviate from the spirit or intent of the present invention are also included. For example, the following embodiment is detailed descriptions of the present invention and is not necessarily limited to having all the configurations included in the description.

In the configuration of the invention described below, the same reference numerals are used consistently across different drawings for identical parts or parts having similar functions, and redundant descriptions may be omitted.

The designations "first," "second," "third," etc., in this specification are used to identify components and do not necessarily limit their number, order, or content. Furthermore, the numbers used to identify components are context-dependent, a number used in one context does not necessarily indicate the same component in another context. Furthermore, an element identified by one number may also perform the function of an element identified by another number.

The positions, sizes, shapes, and ranges of each component shown in the drawings, etc., may not represent the actual positions, sizes, shapes, or ranges, but are intended to facilitate understanding of the invention. Therefore, the present invention is not necessarily limited to the positions, sizes, shapes, or ranges disclosed in the drawings, etc.

Unless otherwise clearly indicated by the context, components expressed in the singular in this specification shall be understood to include the plural.

The hierarchical classification used in this specification to convert operations into natural language format includes "hierarchical classification by granularity" and "hierarchical classification by importance." "Hierarchical classification by granularity" refers to representing an operation in multiple expressions based on the spatio-temporal granularity used to divide the operation for understanding. For example, expressions based on worker operations, etc., are also included in "hierarchical classification by granularity."

"Hierarchical classification by importance" refers to representing operations in multiple expressions according to the importance of operation features in the work being performed. For example, expressions based on worker posture, etc., are also included in "hierarchical classification by importance."

Such technology can be utilized, for example, in worker assistance during factory operations.

### Embodiment

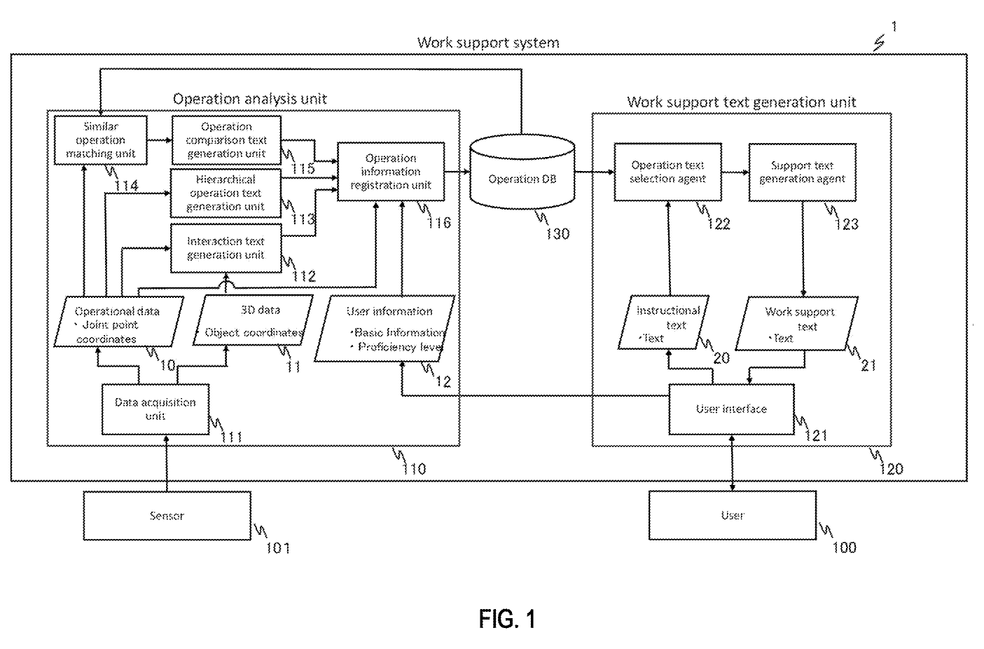

FIG. 1 is an example block diagram showing the system configuration of the work support text system in the embodiment.

In the embodiment, the data acquisition unit 111 receives raw data acquired from various sensors 101 for measuring the work of the user 100, who is the worker.

The sensor data received by the data acquisition unit 111 from the sensors 101 includes RGB image data acquired from cameras, acceleration data acquired from velocity sensors, angular velocity data acquired from angular velocity sensors, and LiDAR or ToF data acquired from 3D sensors.

Sensor data from sensor 101 is sent to data acquisition unit 111, where operational data 10, recording the time-series transition of joint point coordinates, and 3D data 11, recording the position information of objects and the environment related to the task in 3D coordinates are created.

The operation analysis unit 110 includes, in addition to the data acquisition unit 111, an interaction text generation unit 112, a hierarchical operation text generation unit 113, a similar operation matching unit 114, an operation comparison text generation unit 115, and an operation information registration unit 116.

The operational data 10 is input to the interaction text generation unit 112, hierarchical operation text generation unit 113, and similar operation matching unit 114, respectively, and is used to generate explanatory text containing operation information.

The interaction text generation unit 112 acquires operational data 10 and 3D data 11 from the data acquisition unit 111 and generates interaction text, which is an operation description text containing information related to interactions with objects and positional relationships in the environment.

The hierarchical operation text generation unit 113 acquires operational data 10 from the data acquisition unit 111. It converts the operation into natural language format based on the operation's "hierarchical classification by granularity" and "hierarchical classification by importance," generating hierarchical operation text, which is a group of hierarchical operation description texts.

The similar operation matching unit 114 compares the operational data 10 acquired from the data acquisition unit 111 with past operation information registered in the operation database to retrieve similar past operational data. It inputs the retrieved past operational data and the operational data 10 into the operation comparison text generation unit 115 to generate an operation comparison text, which is an operation description text containing the difference information between the two operational data.

The similar operation matching unit 114, operation comparison text generation unit 115, hierarchical operation text generation unit 113, and interaction text generation unit 112 may be implemented using generative AI. Furthermore, these processing units may be configured such that several processing units are combined into a single processing unit.

In this embodiment, these processing units are incorporated in the operation analysis unit 110. However, it is also possible to send the operational data 10, 3D data 11, user information 12, and a prompt indicating the processing content to a general-purpose generative AI outside the work support system 1 and receive the processing results.

The operation information registration unit 116 inputs the operational data 10, interaction text generated by the interaction text generation unit 112, hierarchical operation text generated by the hierarchical operation text generation unit 113, operation comparison text generated by the operation comparison text generation unit 115, and user information 12 acquired via the user interface 121. It associates the operation information linked to the user and registers them in operation DB 130.

The work support text generation unit 120 includes the user interface 121, the operation text selection agent 122, and the support text generation agent 123.

The user interface 121 sends the instructional text 20, which is a request for work support received from the user 100, to the operation text selection agent 122. The operation text selection agent 122 receives a group of operation texts related to the support content from the operation DB 130 based on the instructional text 20 and sends them together with the instructional text 20 to the support text generation agent 123.

Support text generation agent 123 receives instructional text 20 and a group of operation description texts selected from operation DB 130 from operation text selection agent 122, and generates work support text 21 based on instructional text 20.

The generated work support text 21 is provided to user 100 via user interface 121. User interface 121 may also be referred to as an input unit or output unit.

The operation text selection agent 122 and the support text generation agent 123 may be implemented using generative AI. Furthermore, while this embodiment describes the operation text selection agent 122 and support text generation agent 123 as being incorporated within the work support text generation unit 120, it is also possible to send the instructional text converted into a prompt to a general-purpose generative AI external to the work support system 1, have it reference the operation DB 130, and have it create the work support text 21.

Furthermore, operation text selection agent 122 and support text generation agent 123 may be configured as a single module.

The work support system 1, including the operation analysis unit 110 and the work support text generation unit 120, can be implemented on a general-purpose standalone server. The hardware configuration around the server includes input devices, output devices, processing devices, and storage devices. It may also be implemented using a cloud system that provides computing resources.

In this embodiment, functions such as computation and control are realized by a program stored in the storage device being executed by the processing device, thereby performing specified processing in cooperation with other hardware. Fig.1 shows only the functional blocks representing these functions.

The above configuration may be implemented on a single server, or any part of the input device, output device, processing device, and storage device may be implemented on other computers connected via a network.

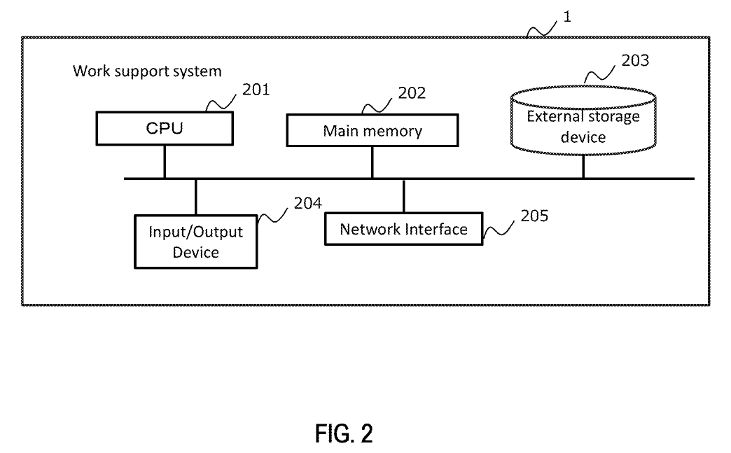

FIG. 2 is an example of a hardware configuration diagram for the work support system in an embodiment.

The work support system 1 comprises a CPU (Central Processing Unit) 201, main memory 202, external memory 203, input/output device 204, and network interface 205, all connected via a bus.

The CPU 201 may also be a processor such as a GPU (Graphics Processing Unit). The main memory 202 is a semiconductor device such as a ROM (Read Only Memory), RAM (Random Access Memory), or other semiconductor devices. The external storage device 203 is a storage device such as an HDD (Hard Disk Drive) or SSD (Solid State Drive), and the input/output device 204 is a keyboard, mouse, touch panel, etc. The network interface 205 is a device such as a NIC (Network Interface Card).

The main memory device 202 stores the following units implemented as software modules, similar operation matching unit 114, operation comparison text generation unit 115, hierarchical operation text generation unit 113, interaction text generation unit 112, operation information registration unit 116, data acquisition unit 111, operation text selection agent 122, support text generation agent 123, and user interface 121.

External storage device 203 stores data such as operational data 10, 3D data 11, user information 12, operation DB 130, instructional text 20, and work support text 21.

The functions of the work support system 1 are realized by the software module stored in the main memory 202 referencing the data stored in the external storage device 203 and being executed by the CPU 201.

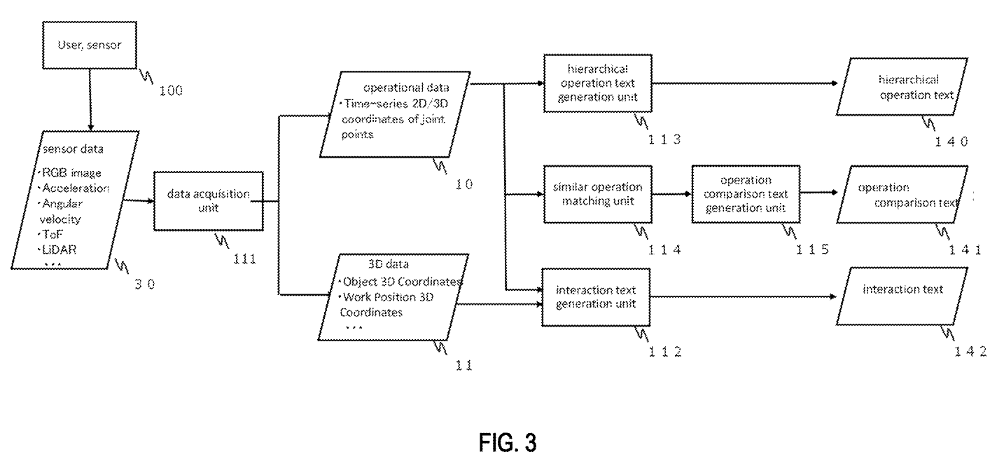

FIG. 3 is an example of a data relationship diagram for the work support system in the embodiment.

RGB images capturing the positions of markers indicating joint points attached to user 100's workwear, along with sensor data such as acceleration, angular velocity, TOF, and LiDAR, are received by data acquisition unit 111 and become operational data 10 and 3D data 11.

Operational data 10 represents the transition of the user 100's operations over time, for example, time-series data of the two-dimensional or three-dimensional coordinates of major joint points on the human skeleton.

For sensors acquiring operational data 10, it is desirable to select one or more types of sensors capable of calculating joint point coordinates from worker motion information (e.g., accelerometers, angular velocity sensors) or sensors capable of inferring joint point coordinates from images (e.g., cameras).

The operational data 10 is sent to the interaction text generation unit 112, the hierarchical operation text generation unit 113, and the similar operation matching unit 114. The hierarchical operation text generation unit 113 generates hierarchical operation text 140, and the operation comparison text generation unit 115 generates operation comparison text 141 using the selected operational data 10 from the similar operation matching unit 114.

The interaction text generation unit receives operational data 10 and 3D data, and generates interaction text 142. The generated hierarchical operation text 140, operation comparison text 141, and interaction text 142 are sent to the operation information registration unit 116 and registered in the operation DB 130.

3D data 11 represents environmental position data during work, such as the transition of 3D coordinates of objects involved in the work or the transition of 3D coordinates of the user 100's work position. For sensors acquiring 3D data 11, it is desirable to select one or more types of sensors capable of inferring object positions or work positions from images, such as cameras, or 3D sensors like ToF or LiDAR.

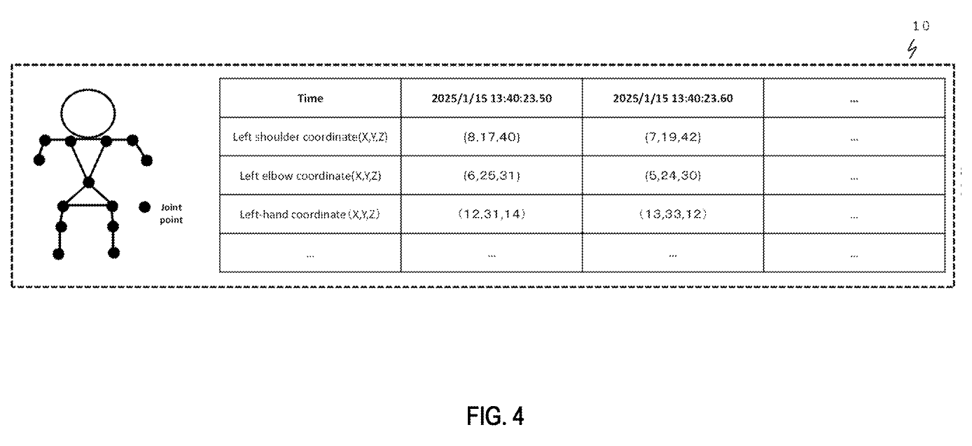

FIG. 4 is an example of operational data in an embodiment. It stores the three-dimensional positions over time of image information, such as markers indicating joint points attached to the worker's work clothes. Operation information may also be received using equipment that directly detects joint point position information rather than markers. Operational data enables recognition not only of the worker's position but also of their movements and posture .

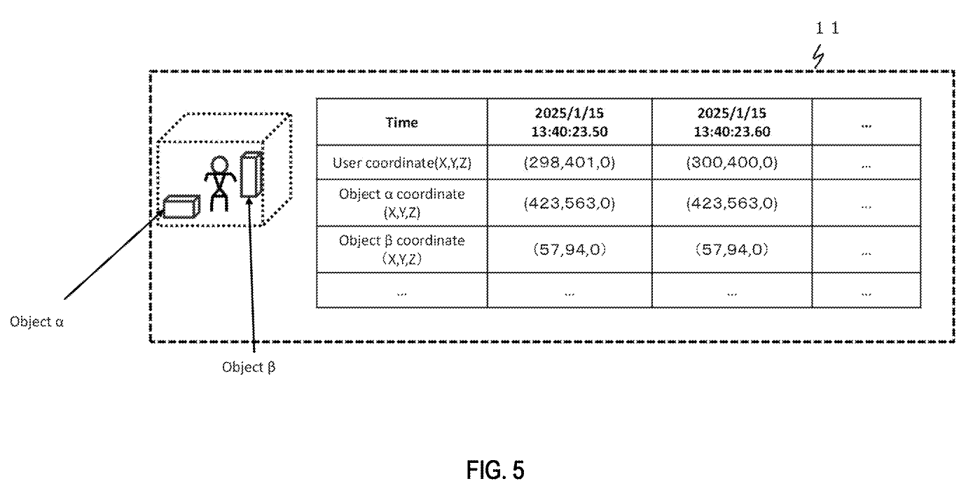

FIG. 5 is an example of 3D data in an embodiment. It illustrates an example where 3D data 11 includes the user coordinate within the work space and the position coordinates of object α and object β. The user coordinate and the position coordinates of object α and object β are acquired as absolute coordinates. Using operational data 10 and 3D data 11 as input, the system outputs text describing the operations interacting with the environment, for example, through a natural language generation model utilizing a deep neural network.

Combining the operation with the environment's 3D information enables expression of the location where the operation occurred. For example, it can recognize the positions and movement paths before and after the work, as well as which object the screw tightening operation was performed on. This enables implementation of safety measures and error prevention support against working in hazardous locations or mistaking the work object.

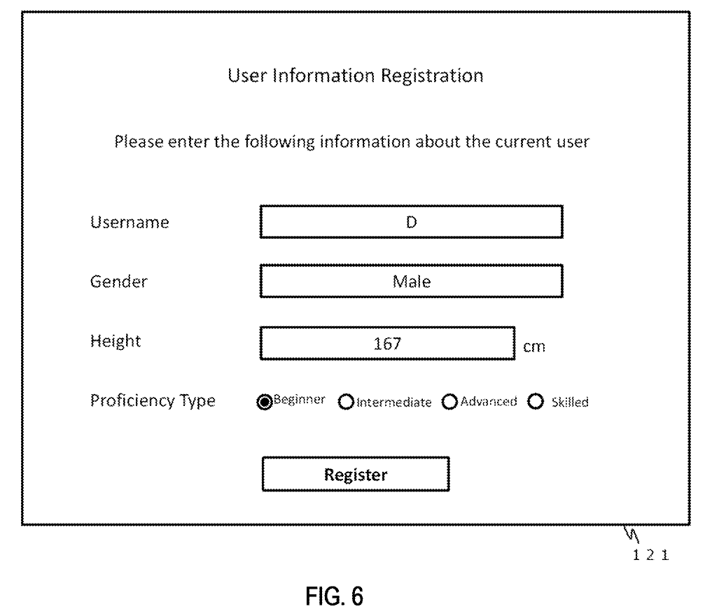

FIG. 6 is an example of the user information registration screen in an embodiment. It illustrates registering items indicating worker characteristics, such as user name, gender, height, and proficiency type as user information 12.

This user information is acquired via the user interface 121, linked when registering operational data 10 in the operation DB 130, and used as a key when searching registered past operational data 10. Other optional items related to the work or worker, such as department, work location, or assigned product, may also be added. The registered user information 12 is sent to the operation information registration unit 116.

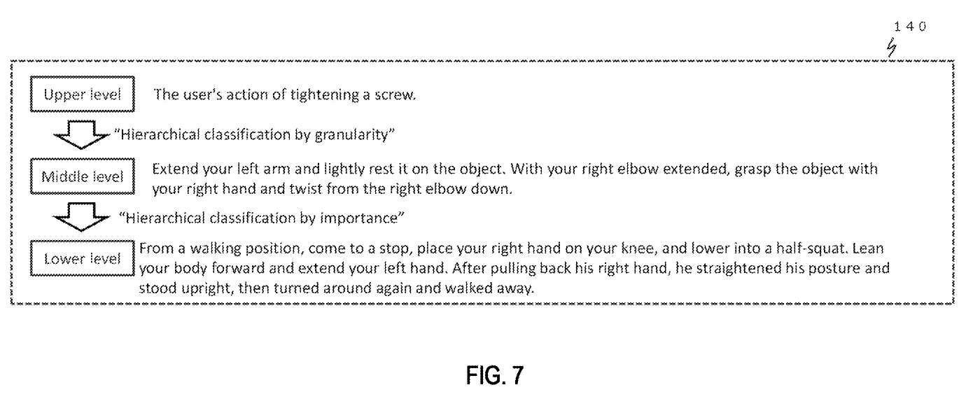

FIG. 7 is an example of hierarchical operation text in an embodiment. It illustrates generating hierarchical operation text 140 from operational data 10, which began recording at 13:40:23.50 on January 15, 2025. From the time-series data of each joint point coordinate, the operation is output as text, for example, through a natural language generation model using a deep neural network.

The time-series data for each joint coordinate may be absolute coordinates in the workspace or relative coordinates from a reference joint of the skeleton. At the upper level, a text concisely indicating the work content signified by the motion is output. At the middle level, "hierarchical classification by granularity" is performed on the upper level text, outputting text describing motions related to work content in small, spatio-temporally segmented regions.

Furthermore, the lower level performs "hierarchical classification by importance" on the text from the middle level, outputting text describing operation elements such as the worker's posture that are less relevant to the operation in each small region.

In this example, one block of operation text is output for each of the upper, middle, and lower layers. However, in each layer, text can be further grouped by body part or other criteria to output multiple types of text.

Outputting operation text hierarchically enables expressing work operations from multiple perspectives closer to human understanding. The generated hierarchical operation text is sent to the operation information registration unit 116.

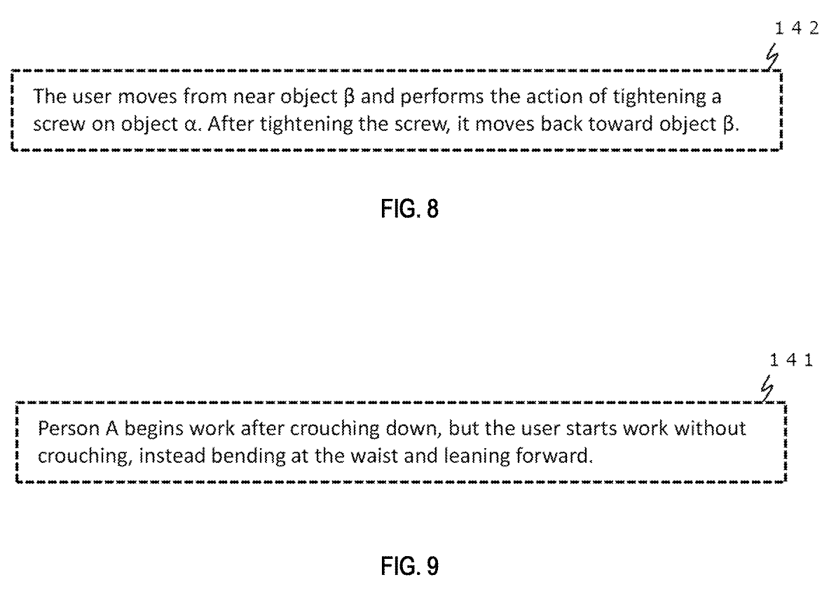

FIG. 8 is an example of interaction text in the embodiment.

Interaction text 142, generated by interaction text generation unit 112 from operational data 10 and 3D data 11, is sent to operation information registration unit 116. This example explains not only the worker's operation but also the positional relationship with object α and object β, and that the worker's operation is directed toward object α.

FIG. 9 is an example of operation comparison text in the embodiment. Using operational data 10 and past similar operational data received from the similar operation matching unit 114 as input, it outputs a comparison with similar operations as text, for example, through a natural language generation model using a deep neural network.

It references the operational data of skilled worker A as past operational data and outputs the differences compared to the user's operations as text. This enables explicit expressions of which parts of the operation are incorrect or unnecessary compared to the skilled worker.

Additionally, by limiting the input to similar operational data from the same user in the past in the similar operation matching unit 114, it is conceivable to use this for purposes such as recording points of improvement when compared to one's past self. The generated operation comparison text 141 is sent to the operation information registration unit 116.

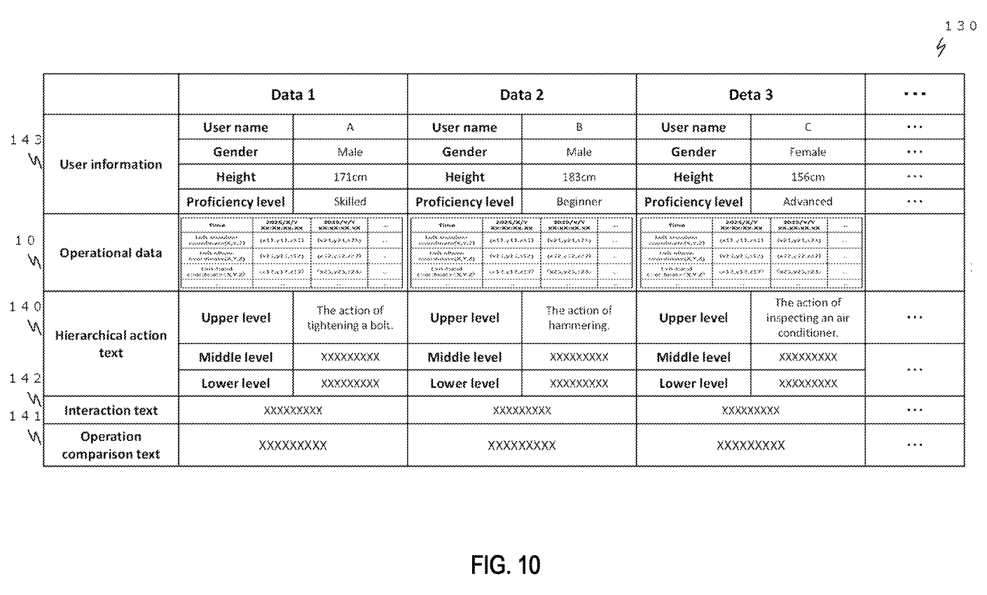

FIG. 10 is an example of an operation DB in the embodiment. The operation information registration unit 116 receives operational data 10 from the data acquisition unit 111, user information 12 from the user interface 121, interaction text 142 from the interaction text generation unit 112, hierarchical operation text 140 from the hierarchical operation text generation unit 113, and operation comparison text 141 from the operation comparison text generation unit 115, and operation comparison text 141 received from the operation comparison text generation unit 115. It then compiles the user information 12 corresponding to this operational data and the various operation texts into the format of the user's operation information and stores it in the operation DB 130.

The operation DB 130 organizes the stored operation information for each user by column. This allows various operation texts to be extracted using keys such as items in the user information or the timestamp information of the operational data.

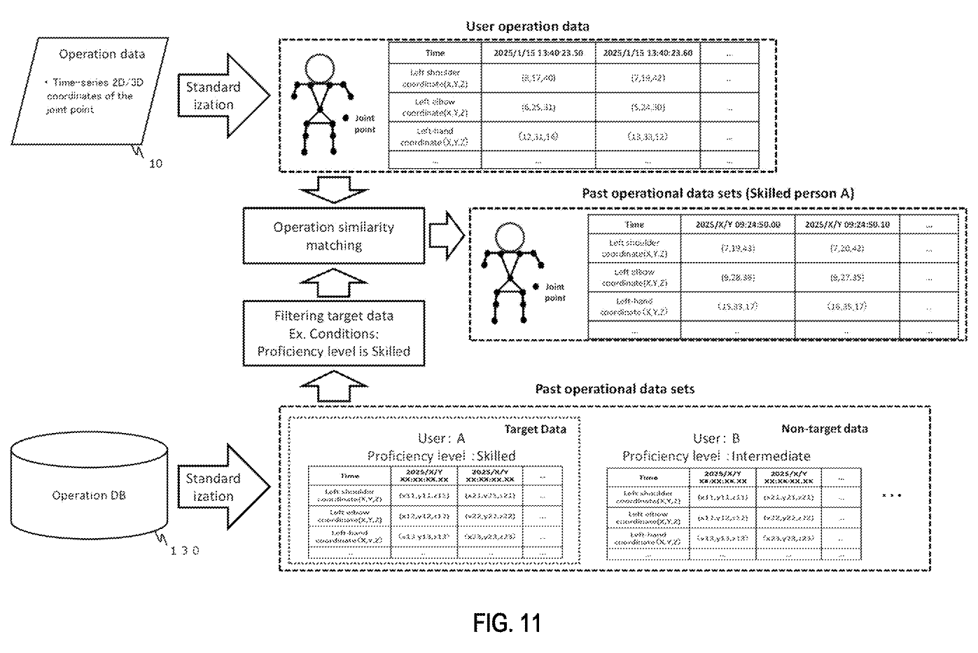

FIG. 11 is a diagram showing the processing of the similar operation matching unit in the embodiment. The similar operation matching unit 114 compares the user's operational data 10 with past operational data stored in the operation DB 130 and outputs the most similar past operational data for generating the operation comparison text.

To ensure accurate matching of operational data, each data set undergoes standardization processing before matching to align the rotation axes and scales of the coordinates. As a method for standardizing the rotation axes of coordinates, one approach involves rotating such that the vector from the left shoulder to the right shoulder of the first data column in each time series of operational data aligns with the x-axis, and the vector from the midpoint between the right hip and left hip to the midpoint between the right shoulder and left shoulder aligns with the z-axis.

For scale standardization, one approach involves unifying the distance between the left shoulder and right shoulder of the first data column in each time series operational data to a fixed length. After applying standardization processing to each data set, the target data is filtered from the historical operational data group, and all filtered target data is then compared with the user's operational data.

While the target data is filtered based on proficiency level, other filtering criteria, such as date, may also be used. The past operational data with the highest similarity is output as a result of the comparison and sent to the operation comparison text generation unit 115.

Furthermore, if the operational data coordinates are not based on the same viewpoint, standardization to align viewpoints is required.

Regarding time, if the operational data does not record coordinates at the same time interval, it must be normalized to the time interval of the operational data with the longest time interval among the operational data being compared.

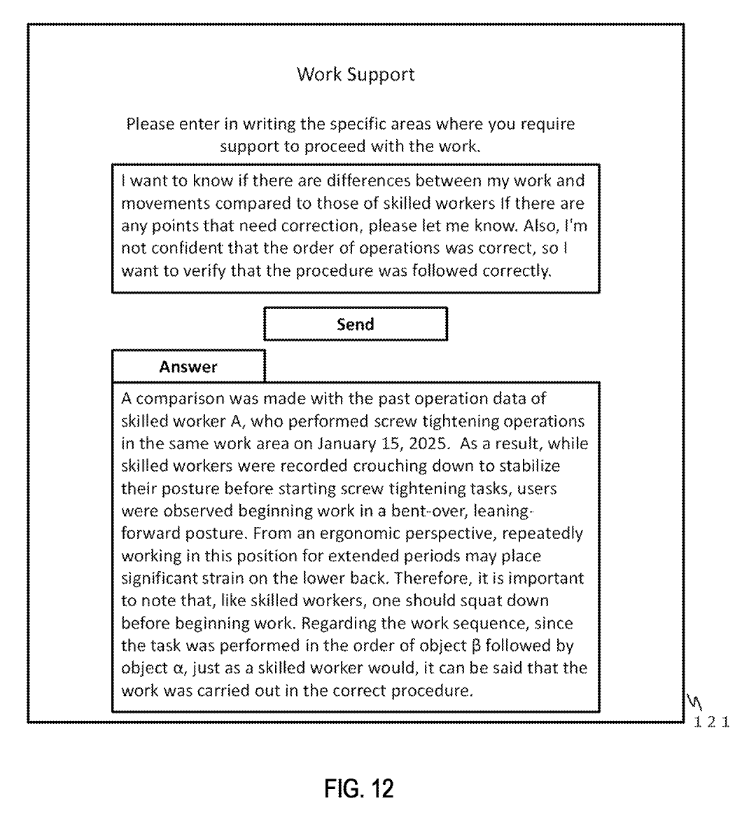

FIG. 12 is an example of the work support screen in the embodiment.

It shows an example where the user inputs and sends the required support content as instructional text.

The upper section shows the instructional text entered by the worker, while the lower section shows the response generated by the work support system to that instructional text. After entering the instructional text, the worker presses the send button to receive the response.

The instructional text input method may be via keyboard input or other methods such as voice input. Pressing the send button transmits the input text as instructional text 20 to the operation text selection agent 122.

An example is shown where the work support text generated according to the instructional text 20 input by user 100 is visually displayed on a tablet device, etc., and presented to user 100. The method for outputting the work support text is not limited to a tablet device. It may also be presented on the screen of smart glasses. Alternatively, by using voice to read aloud the text, real-time advice can be provided to the worker performing the work at the work site.

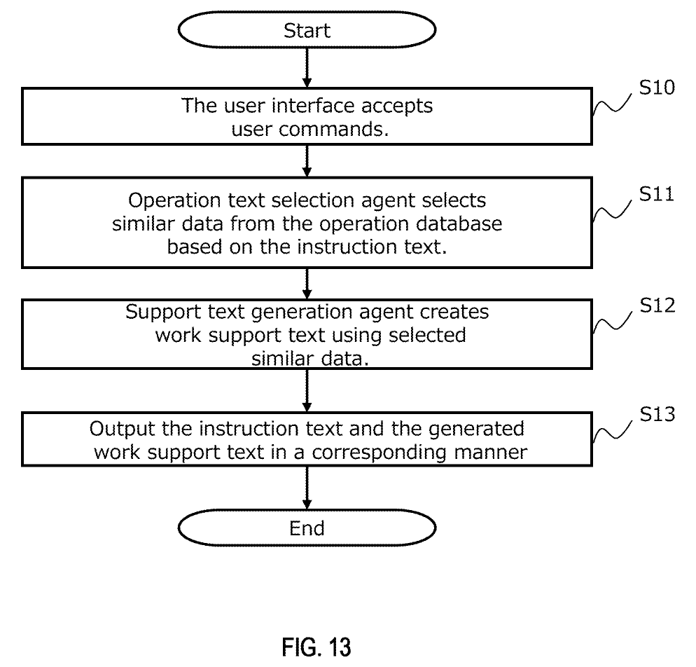

FIG. 13 is an example flowchart illustrating the work support processing in the embodiment.

The user interface 121 receives the user's instructional text 20 (S10), and the operation text selection agent 122 selects similar data for comparison from the operation DB 130 based on the instructional text 20 (S11).

The support text generation agent 123 creates work support text using the similar data selected by the operation text selection agent 122 (S10), associates the created work support text with the instructional text 20, and outputs it to the user interface 121 (S10).

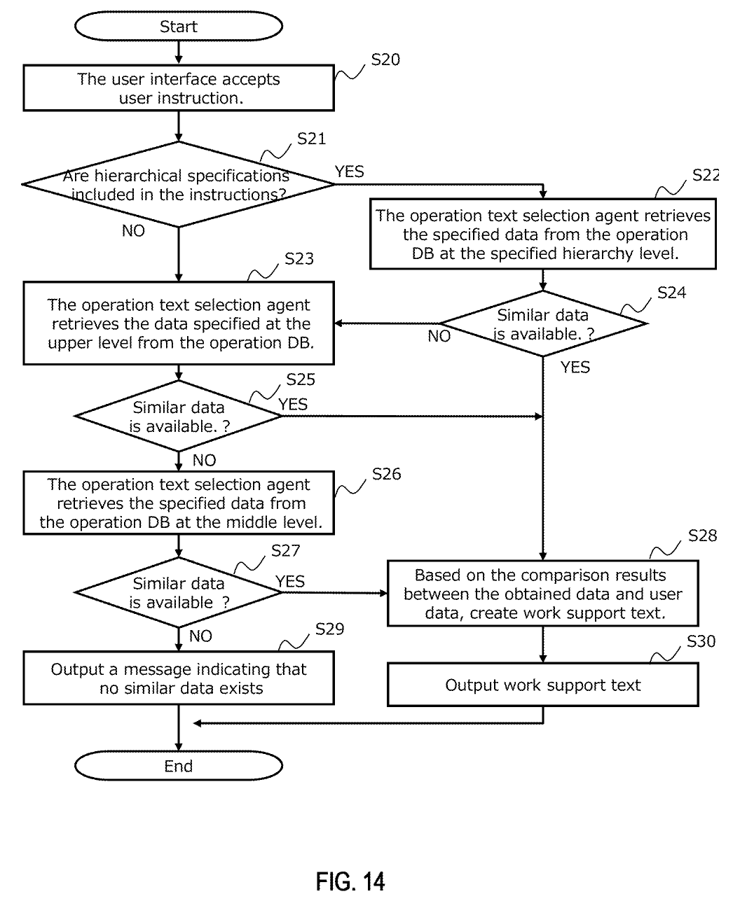

FIG. 14 is an example flowchart illustrating when the hierarchy specified work support processing in the embodiment.

User interface 121 receives the user's instructional text 20 (S20) and determines whether the received instructional text 20 contains a hierarchy specification (S21). If no hierarchy specification is included, operation text selection agent 122 searches for data specified at the upper level in operation DB 130 (S23).

It determines whether similar data for comparison exists in the operation DB 130. If no similar data exists, the operation text selection agent searches the operation DB for data specified at the middle level (S26). It determines whether similar data exists at the middle level (S27). If similar data for comparison exists, it creates a work support text based on the comparison result between the obtained data and the user data (S28), and outputs the work support text (S30). If no similar data for comparison exists, it outputs a message indicating that no similar data was found (S29).

When the instructional text 20 in S21 has a hierarchy specification, the operation text selection agent 122 searches for the specified data at the specified hierarchy level in the operation DB 130 (S22). It determines whether there is similar data for comparison (S24). If there is, it proceeds to the processing in S28. If there is no similar data for comparison, it proceeds to S23, which searches for the specified data at the upper level in the operation DB 130.

This embodiment is described assuming two levels comprising an upper level and a middle level. However, multiple upper level and multiple middle level may also be provided. Establishing multiple levels enables obtaining appropriate comparable similar data between the most upper level and the lowest middle level.

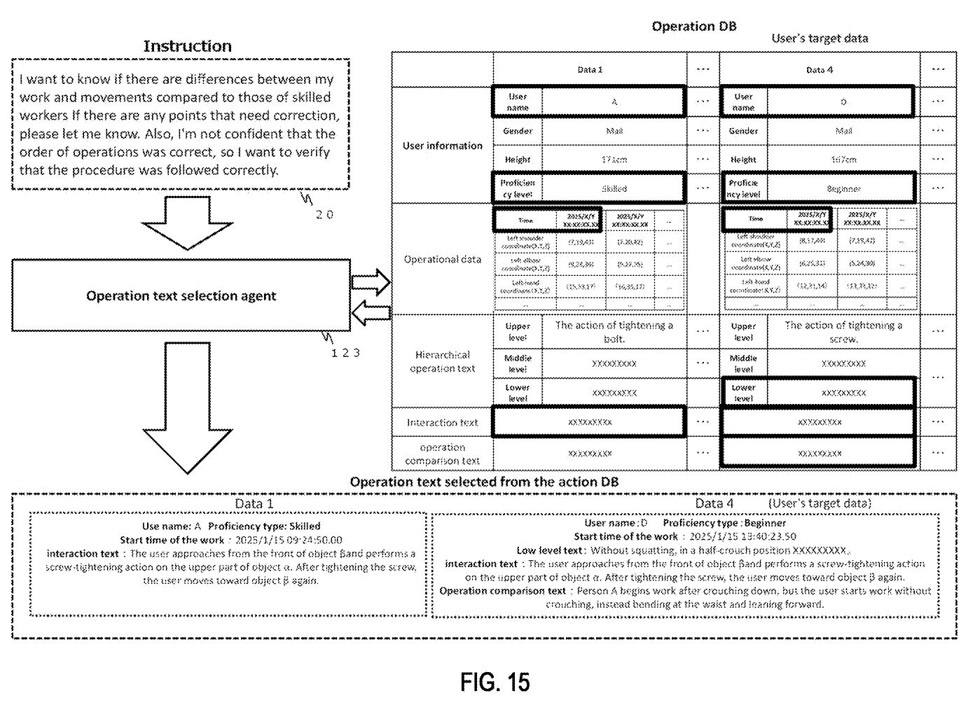

FIG. 15 is a diagram illustrating the processing of the operation text selection agent in the embodiment. The operation text selection agent 122 takes the instructional text 20 received from the user interface 121 as input, selects multiple appropriate operation texts from the operation DB 130, and outputs them associated with the necessary user information.

The operation text selection agent 122 is an agent specialized in understanding the data structure of the operation database and interpreting the instructional text to extract appropriate operation texts. For example, generative AI based on a large-scale language model may be used.

The instructional text 20 indicates that the worker's request for assistance consists of two parts: first, the results of comparing operations with a skilled worker, and second, confirming the target procedure. Therefore, the system selects the operation comparison text from data 4 which contains descriptions of operation comparisons with skilled workers, and the interaction text from data 1 which describes the work procedures for both the skilled worker and the target user, along with the interaction text from data 4, and outputs them as operation text.

By explicitly extracting operation text aligned with instructional text 20 via operation text selection agent 122, only the information necessary for actual support text generation is efficiently utilized, enabling the generation of high-precision work support text. The selected set of operation text is sent to support text generation agent 123 along with instructional text 20.

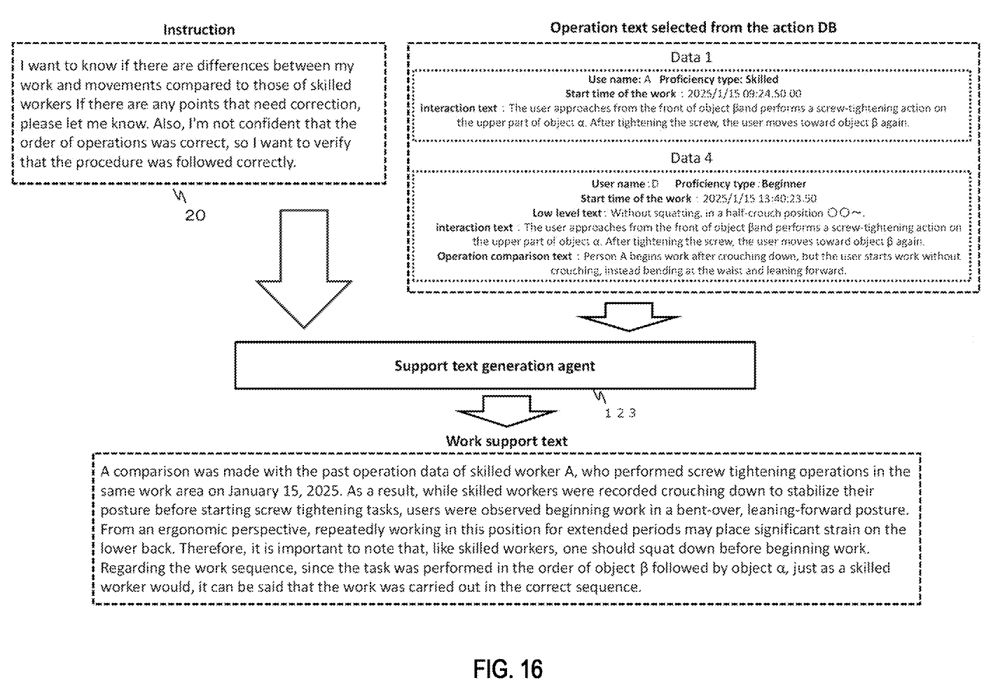

FIG. 16 is a diagram showing the processing of the support text generation agent in the embodiment. The support text generation agent 123 receives the instructional text 20 from the user interface 121 and the selected operation text from the operation text selection agent 122 as input, generates work support text 21, and outputs it.

The support text generation agent 123 uses the instructional text 20 and the operation text group to generate work support text 21 corresponding to the instructional text, for example, via a large language model. It extracts necessary portions from the operation text regarding differences in operation compared to skilled workers and operation procedures related to interactions, thereby generating a batch of work support text. The generated work support text 21 is sent to the user interface 121.

Hierarchical operation text generation unit 113 shows an example where operations are output as hierarchical text, for instance, through a natural language generation model using a deep neural network. However, frequently in actual work sites, the upper level operation text will be the work names themselves, which have a larger spatial temporal granularity often become site specific. Therefore, it is considered necessary to additional learning the natural language generation model for each site.

While additional learning of the natural language model requires a large amount of site-specific data, expressing operations hierarchically and accumulating them in an operation database can resolve this issue of learning data volume.

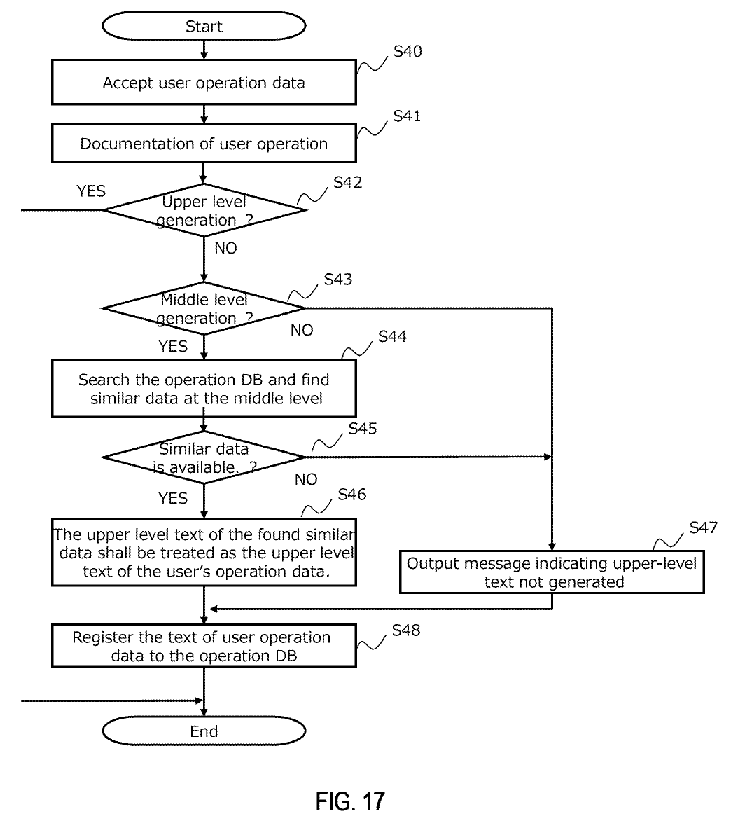

FIG. 17 is an example flowchart of the operational data registration process in the embodiment.

The hierarchical operation text generation unit 113 receives the user's operational data (S40) and converts the user's operations into text (S41). It then determines whether an upper level operation text can be generated for the text converted user operation (S42). The determination criteria may include whether the upper level operation text is unknown or whether the confidence level is low.

If the upper level operation text is determined, the process ends. If not, it determines whether the middle level operation text is determined (S43). If the middle level operation text is not determined, it outputs an upper level text not generated message (S47) and ends the process.

If the middle level operation text is determined, search the operation DB 130 and seek similar data using the middle level operation text (S44). If no similar data is found, proceed to S47. If similar data is found, set the upper level text of the found similar data as the upper level text of the user's operational data (S46), and register the text data of the user's operational data in the operation DB 130.

Furthermore, the processing of the hierarchical operation text generation unit 113 may also be performed by the operation information registration unit 116.

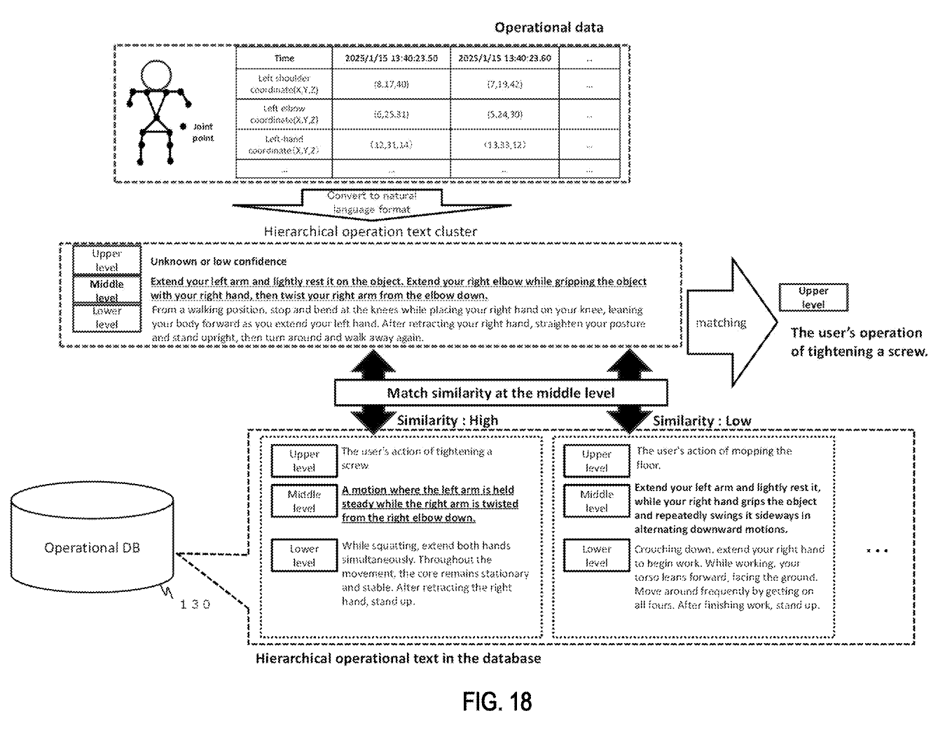

FIG. 18 is a diagram showing the operational data registration process in the embodiment. It explains the processing of hierarchical operation text generation unit 113 in more detail.

Regarding the determination of text confidence, one approach involves, for example, having a natural language processing model output confidence score along with text. If the confidence score falls below a certain threshold, the text is judged to satisfy the requirement. Generally, even when the upper level is site-specific, text at the middle level, which describe operations in finer granularity represent more generic operational descriptions.

However, lower level text often contains less important information and is therefore unsuitable for identifying upper level text.

The similarity between the target middle level operation text and middle level operation texts recorded in the operation database 30 is compared. The upper level operation text simultaneously held by the most similar middle level operation text is referenced and output as the upper level operation text for the target data.

For similarity measurement, any evaluation score used in the natural language field to measure text similarity may be employed. This method eliminates the need to prepare a large number of operation texts specific to the site, and having just one sample per task enables the generation of the correct upper level text through comparison.

### REFERENCE SIGNS LIST

1 Work support system

10 Operational data

113D data

12 User information

20 Instructional text

21 Work support text

30 Sensor data

100 User

101 Sensor

110 Operation analysis unit

111 Data acquisition unit

112 Interaction text generation unit

113 Hierarchical operation text generation unit

114 Similar operation matching unit

115 Operation text generation unit

116 Operation information registration unit

120 Work support text generation unit

122 Operation text selection agent

123 Support text generation agent

121 User interface

130 Operation DB

140 Hierarchical operation text

141 Operation comparison text

142 Interaction text

1. A work support system outputs work support text to improve a worker's operation , the work support system comprising,
a data acquisition unit receives operational data indicating the worker's operation,
a hierarchical operation text generation unit generates operation description texts explaining the operational data across multiple levels,
an operation DB stores the generated operation description text,
an input section receives instructional text for work support from the worker,
an operation text selection agent that selects the worker's operational data and the comparison target operational data specified by the received work support instructional text from the operation DB based on said received work support instructional text,
a support text generation agent that generates work support text based on the requested worker's operational data and the specified comparison operational data;
an output unit that outputs the generated work support text.

2. The work support system according to claim 1,
wherein the hierarchical operation text generation unit generates upper level, middle level, and lower level operation description texts,
and further comprises an operation information registration unit registers the generated upper level, middle level, and lower level operation description texts in the operation DB in a corresponding manner.

3. The work support system according to claim 2,
wherein the hierarchical operation text generation unit, when unable to generate an upper level operation description text,
it references the operation DB to find operational data with a similar middle level operation description text, and registers the upper level operation description text of the found operational data as the upper level operation description text for the work support system.

4. The work support system according to claim 2,
wherein when the input unit receives an instructional text for work support that specifies a hierarchy,
the operation text selection agent searches for comparable operational data at the specified level, and if no comparable operational data is found, it searches for comparable operational data at an upper level.
and when no comparable operational data is found at the upper level, it seeks comparable operational data at the middle level.

5. The work support system according to claim 2,
wherein when the instructional text received by the input unit does not specify a hierarchy,
the work support system seeks comparable operational data at the upper level, and if comparable operational data is not found at the upper level, it seeks comparable operational data at the middle level.

6. The work support system according to claim 1,
wherein the data acquisition unit receives 3D data of items involved in the work,
and includes an interaction text generation unit that generates interaction text containing information about the location where the worker's operations are being performed, based on the operational data and the 3D data,
the operation DB stores interaction text generated in correspondence with the operational data,
the output unit outputs interaction text corresponding to the operational data being compared.

7. The work support system according to claim 1,
wherein the hierarchical operation text generation unit generates hierarchical operation description texts containing the names of operations being performed by the worker in the operational data.

8. The work support system according to claim 1,
wherein the hierarchical operation text generation unit generates hierarchical operation description texts that include the operations being performed by the worker in the operational data.

9. The work support system according to claim 1,
wherein the hierarchical operation text generation unit generates hierarchical operation description texts that include the posture of the operation being performed by the worker in the operational data.

10. The work support system according to claim 1,
wherein the input unit accepts information indicating worker characteristics, including the worker's proficiency level,
wherein the operation text selection agent selects comparative operational data from the operational data matching said characteristics.

11. A work support method outputs work support text to improve a worker's work,
a data acquisition unit receives operational data indicating the worker's operation,
a hierarchical operation text generation unit generates an operation description text explaining the operational data across multiple levels,
an operation DB stores the generated operation description text,
when an input unit receives an instructional text for work support from the worker,
an operation text selection agent selects from the operation DB the worker's operational data, and the comparison target operational data specified by the received work support instructional text,
a work support text generation agent generates work support text based on the operational data of the requested worker and the comparative operational data specified by the work support instructional text,
and an output unit outputs the generated work support text.
